(19) United States
(12) Patent Application Publication
(10) Pub. No.: US 2026/0023272 A1
(43) Pub. Date: Jan. 22, 2026

(54) AERIAL IMAGE FORMING DEVICE

(71) Applicant: LINTEC CORPORATION, Tokyo (JP)

(72) Inventors: Baku KATAGIRI, Tokyo (JP); Kentaro KUSAMA, Tokyo (JP); Naoya KOIZUMI, Tokyo (JP); Makoto OTSUBO, Hiroshima (JP)

(73) Assignee: LINTEC CORPORATION, Tokyo (JP)

(21) Appl. No.: 19/106,835

(22) PCT Filed: Aug. 28, 2023
(86) PCT No.: PCT/JP2023/031054

§ 371 Date: Feb. 26, 2025

(30) Foreign Application Priority Data
Aug. 29, 2022 (JP) 2022-135723

(51) Int. Cl. G02B 30/56

(52) U.S. Cl. CPC G02B 30/56; G02B 2207/123

(57) ABSTRACT

An aerial image forming device includes a display unit that has a display surface and emits light from the display surface; a light diffusion control unit that is disposed on the display surface side of the display unit and diffuses or transmits the light depending on its incident angle; and a light-transmitting image formation unit that is laminated on a surface side of the light diffusion control unit opposite to the display unit, transmits the light transmitted through the light diffusion control unit, and forms an image in a position on a surface side opposite to the light diffusion control unit. The light diffusion control unit has a louver-shaped regular internal structure that includes a plurality of plate-shaped regions having a relatively high refractive index in a region having a relatively low refractive index.

### TECHNICAL FIELD

The present invention relates to an aerial image forming device.

### BACKGROUND ART

An aerial image is an image formed using optical elements, etc. at an arbitrary position in a given space by reflecting/refracting light emitted from a light source. No screen or display is disposed at the position in which the aerial image is displayed, and an observer who sees the aerial image gets a strange sensation. For this reason, aerial images have been used actively in various applications, including virtual reality, in recent years.

For example, Patent Document 1 discloses an aerial image formation device that includes at least a display part and a light-transmission/image-formation part, in which an image (real image) displayed on the display part is displayed as an aerial image mainly by an action of the light-transmission/image-formation part.

### PRIOR ART DOCUMENTS

### Patent Documents

[Patent Document 1] JP2020-060752A

### SUMMARY OF THE INVENTION

### Problems to be Solved by the Invention

When the aerial image formation device is operated, an unintended image called a ghost image may be displayed at the same time as the aerial image. The occurrence of a ghost image is unintended, and it cannot be said that the ghost image accurately reflects the real image. In addition, the ghost image may overlap with the aerial image, making it difficult to visually recognize the aerial image well.

From the viewpoint of suppressing the occurrence of such a ghost image, an optical element (also called a viewing angle control element, privacy film, etc.) that transmits only light entering at a certain incident angle and blocks other light may be provided in the aerial image formation device. By using such an optical element, the light for forming the ghost image is blocked, and the occurrence of a ghost image can thus be suppressed. The optical element, however, acts to block a part of the light emitted from the display part. As a result, the overall brightness is reduced, making it difficult to visually recognize the aerial image brightly, and the contrast ratio of the aerial image is also reduced.

The present invention has been made in consideration of such actual circumstances and an object of the present invention is to provide an aerial image forming device that can satisfactorily suppress the occurrence of a ghost image while maintaining sufficient brightness.

### Means for Solving the Problems

To achieve the above object, first, the present invention provides an aerial image forming device comprising: a display unit that has a display surface and emits light from the display surface; a light diffusion control unit that is disposed on the display surface side of the display unit and diffuses or transmits the light depending on its incident angle; and a light-transmitting image formation unit that is laminated on a surface side of the light diffusion control unit opposite to the display unit, transmits the light transmitted through the light diffusion control unit, and forms an image in a position on a surface side opposite to the light diffusion control unit, the light diffusion control unit having a louver-shaped regular internal structure that includes a plurality of plate-shaped regions having a relatively high refractive index in a region having a relatively low refractive index (Invention 1).

In the above invention (Invention 1), preferably, the display unit may be disposed with respect to the light diffusion control unit and the light-transmitting image formation unit such that the display surface and a surface of the light diffusion control unit opposite to the light-transmitting image formation unit are non-parallel (Invention 2).

In the above invention (Invention 1), preferably, when a direction perpendicular to a longitudinal direction of the plate-shaped regions and existing in the surface of the light diffusion control unit opposite to the light-transmitting image formation unit is defined as a first direction, a and direction parallel to a plane perpendicular to both the display surface and one surface of the light diffusion control unit and existing in the surface of the light diffusion control unit opposite to the light-transmitting image formation unit is defined as a second direction, an acute angle formed between the first direction and the second direction may be 0° or more and 90° or less (Invention 3).

In the above invention (Invention 1), preferably, when a direction perpendicular to a longitudinal direction of the plate-shaped regions and existing in a surface of the light diffusion control unit opposite to the light-transmitting image formation unit is defined as a first direction, each of the plate-shaped regions may be tilted toward the first direction within the light diffusion control unit (Invention 4).

In the above invention (Invention 4), preferably, an angle of tilt of the plate-shaped regions may be 0° or more and 30° or less with respect to a thickness direction of the light diffusion control unit (Invention 5).

In the above invention (Invention 1), preferably, the light-transmitting image formation unit may include a retro-transmitting optical element that retro-transmits incident light (Invention 6).

In the above invention (Invention 6), preferably, the retro-transmitting optical element may be configured such that two layers each including a plurality of reflective surfaces are laminated, in each of the two layers, the plurality of reflective surfaces may be arranged perpendicular to one surface of the retro-transmitting optical element and at a predetermined distance from each other, and the two layers may be laminated so that the reflective surfaces in one layer of the two layers are perpendicular to the reflective surfaces in the other layer of the two layers (Invention 7).

In the above invention (Invention 7), preferably, provided that a plane F that is perpendicular to both a surface of the light-transmitting image formation unit opposite to the light diffusion control unit and the display surface and that passes through a center point of the light-transmitting image formation unit is assumed and a width of the light-transmitting image formation unit in a cross section obtained by cutting the light-transmitting image formation unit at the plane F is width W, upon observation of the aerial image forming device from an observation point that exists within the plane F and satisfies both of Condition A and Condition B below:
(Condition A)
when an angle between a line segment connecting the observation point and the center point and the surface of the light-transmitting image formation unit opposite to the light diffusion control unit is angle α, and an angle between a plane including the display surface of the display unit and a plane including the surface of the light-transmitting image formation unit opposite to the light diffusion control unit is angle β, a total of the angles α and β is 90°; and
(Condition B)
a distance between the observation point and the center point is 3.5 times the width W,
the light diffusion control unit may be configured such that: in the light that is emitted from any one point on the display unit and reaches the observation point, light that is reflected by both of the two layers constituting the retro-transmitting optical element gives a haze value of 60% or less; and in the light that is emitted from any one point on the display unit and reaches the observation point, light that is reflected by only one of the two layers constituting the retro-transmitting optical element gives a haze value of 60% or more (Invention 8).

### Advantageous Effect of the Invention

The aerial image forming device according to the present invention can satisfactorily suppress the occurrence of a ghost image while maintaining sufficient brightness.

### BRIEF DESCRIPTION OF DRAWINGS

FIG. 1 is a cross-sectional view schematically illustrating an example of the aerial image forming device according to an embodiment of the present invention.

FIG. 2 is a perspective view schematically illustrating an internal structure of a light diffusion control unit.

FIG. 3 is a diagram for explaining the relationship between the optical characteristics of the light diffusion control unit and the light that forms an aerial image and a ghost image.

FIG. 4 is a set of cross-sectional views schematically illustrating the light diffusion control unit according to Example 1, Comparative Example 1, and Comparative Example 2.

FIG. 5 is a set of diagrams for explaining the incident range, identified in Testing Example 1, of light that forms an aerial image and a ghost image.

FIG. 6 is a set of graphs illustrating the results of optical characteristics of the light diffusion control unit measured in Testing Example 1.

FIG. 7 is a set of images showing aerial images and ghost images captured in Testing Example 2.

### EMBODIMENTS FOR CARRYING OUT THE INVENTION

Hereinafter, one or more embodiments of the present invention will be described.

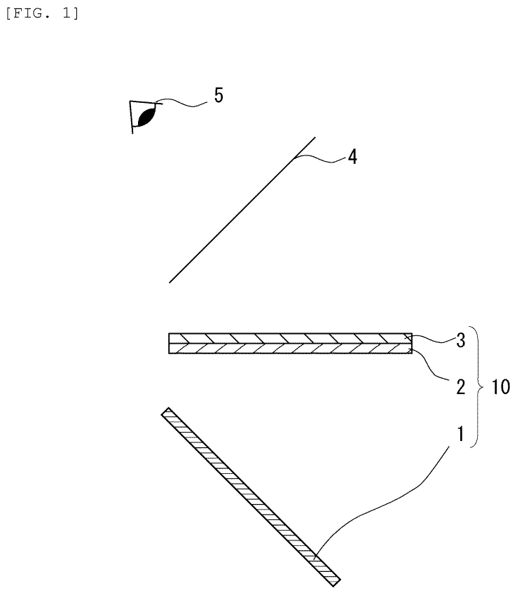

FIG. 1 is a cross-sectional view schematically illustrating an example of the aerial image forming device according to an embodiment of the present invention. As illustrated in FIG. 1, aerial image forming device 10 according to the present embodiment includes: a display unit 1 that has a display surface and emits light from the display surface; a light diffusion control unit 2 that is disposed on the display surface side of the display unit 1 and diffuses or transmits the light depending on its incident angle; and a light-transmitting image formation unit 3 that is laminated on a surface side of the light diffusion control unit 2 opposite to the display unit 1, transmits the light transmitted through the light diffusion control unit 2, and forms an image in a position on a surface side opposite to the light diffusion control unit 2.

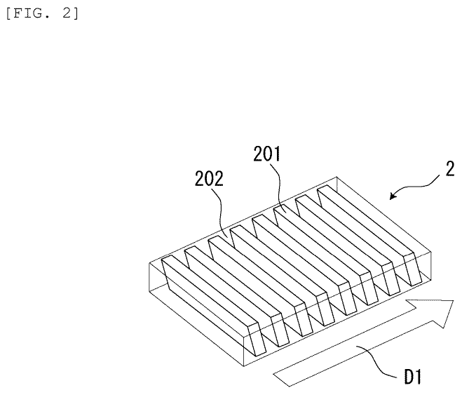

FIG. 2 is a perspective view schematically illustrating the internal structure of the light diffusion control unit. As illustrated in FIG. 2, the light diffusion control unit 2 has a louver-shaped regular internal structure that includes a plurality of plate-shaped regions 201 having a relatively high refractive index in a region 202 having a relatively low refractive index. By having the regular internal structure, the light diffusion control unit 2 allows the light incident on the surface of the light diffusion control unit 2 within a predetermined incident angle range to exit while being strongly diffused with a predetermined opening angle. On the other hand, when the incident light falls outside the above incident angle range, the incident light can transmit through the light diffusion control unit 2 without being diffused or exit the light diffusion control unit 2 with weaker diffusion than that in the case of the incident light within the incident angle range. The direction perpendicular to the longitudinal direction of the plate-shaped regions 201 and existing on the surface of the light diffusion control unit 2 opposite to the light-transmitting image formation unit 3 (direction indicated by “D1” in FIG. 2) will be referred to as a “first direction.”

When the aerial image forming device 10 according to the present embodiment displays a desired image (real image) on the display surface of the display unit 1, an image (aerial image) formed as if the above real image is formed in the air can be visually recognized in the position indicated by reference numeral “4” in FIG. 1 when viewed from a predetermined observation point 5. In the present specification, the surface in the position indicated by reference numeral “4” will be referred to as an “aerial image observation surface.”

Here, in the conventional aerial image formation device, an image called a ghost image may also be displayed together with the aerial image. The ghost image refers to an image that reflects a real image and is displayed around the aerial image on the aerial image observation plane 4, even though it is not displayed on the display surface of the display unit 1. For the purpose of suppressing the occurrence of such a ghost image, an optical element that blocks only the light that contributes to the formation of a ghost image may be used. The optical element, however, blocks a part of the light emitted from the display unit 1, so the brightness of the aerial image is reduced, making it difficult for the viewer to visually recognize the aerial image.

In contrast, the aerial image forming device 10 according to the present embodiment includes the light diffusion control 2 thereby effectively suppress the occurrence of a ghost image while maintaining sufficient brightness of the aerial image. As will be described below, such an effect is presumed to be due to the action of the light diffusion control unit 2. Note, however, that it is not limited to this action, and the possibility of other actions being present is not denied.

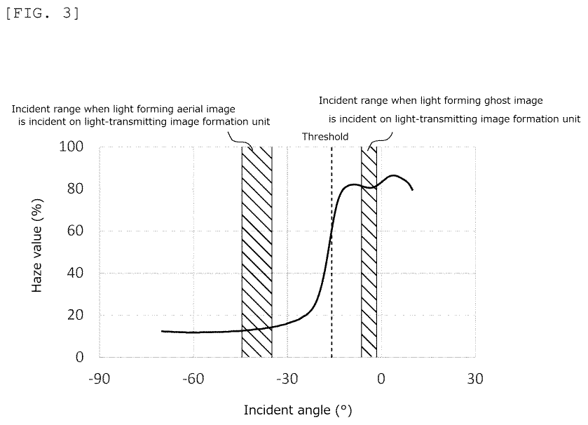

FIG. 3 is a diagram for explaining the action of the light diffusion control unit 2, and in particular, a diagram for explaining the relationship between the optical characteristics of the light diffusion control unit 2 and the light that forms an aerial image and a ghost image.

As described previously, the light diffusion control unit 2 diffuses and transmits light incident within a predetermined incident angle range and transmits light incident outside the predetermined incident angle range with almost no diffusion. The graph of FIG. 3 illustrates the relationship between the incident angle of light incident on the light diffusion control unit 2 and the haze value. Specifically, it is illustrated that the haze value exceeds 80% for light incident from an incident angle range of about −10° to about 10° (i.e., the light is diffused and transmitted). On the other hand, it is also illustrated that the haze value is about 15% for light incident from an incident angle range of about −70° to about −20° (i.e., the light is transmitted with almost no diffusion). The incident angle at which the haze value varies greatly (near −15° in FIG. 3) may be referred to as a “threshold.”

Here, the above-described “haze value” is different from the usual “haze” and is a measurement value obtained through setting a predetermined distance between the integrating sphere opening and the sample and varying the incident angle to the sample. In the measurements in the present specification, the predetermined distance is set to 20 mm, but the value is not particularly limited, provided that the value allows the straight transmission/diffuse transmission of incident light to be confirmed.

In the aerial image forming device 10 according to the present embodiment, the light diffusion control unit 2 exhibiting the above optical characteristics is present between the display unit 1 and the light-transmitting image formation unit 3, so that the light diffusion control unit 2 allows the light for forming the aerial image to reach the light-transmitting image formation unit 3 satisfactorily, while causing the light for forming the ghost image to reach the light-transmitting image formation unit 3 in a diffused state. This allows the viewer to visually recognize the aerial image clearly, while making it difficult to visually recognize the ghost image. The light diffusion control unit 2 controls the diffusion of light rather than blocking light, and it is therefore possible to display the aerial image with sufficient brightness while suppressing the occurrence of a ghost image.

It should be noted that a better effect can be achieved through appropriately adjusting the type of the light diffusion control unit 2 and the laminate state with the light-transmitting image formation unit 3, etc. and adjusting so that, as illustrated in FIG. 3, the threshold is located between the incident angle range of light for forming an aerial image and the incident angle range of light for forming a ghost image.

### 1. Display Unit

The display unit 1 constituting the aerial image forming device 10 according to the present embodiment is not particularly limited, provided that it has a display surface and can display an image or video on the display surface and emit the light toward the light diffusion control unit 2 and the light-transmitting image formation unit 3. As the display unit 1, for example, a liquid crystal display (LCD), a light emitting diode (LED) display, an organic electroluminescence (organic EL) display, etc. can be used.

The positional relationships between the display unit 1, the light diffusion control unit 2, and the light-transmitting image formation unit 3 are not particularly limited. As illustrated in FIG. 1, it is preferred that the display unit 1 and the light diffusion control unit 2 should be sufficiently separated and there should be a space between them. It is also preferred that the display unit 1 should be disposed with respect to the light diffusion control unit 2 and the light-transmitting image formation unit 3 such that the display surface of the display unit 1 and the surface of the light diffusion control unit 2 opposite to the light-transmitting image formation unit 3 are non-parallel. Such a positional relationship allows the aerial image to be displayed better.

### 2. Light Diffusion Control Unit

The light diffusion control unit 2 constituting the aerial image forming device 10 according to the present embodiment is not particularly limited, provided that it has the aforementioned louver-shaped regular internal structure.

From the viewpoint of easily forming the above regular internal structure, the light diffusion control unit 2 may be preferably obtained by curing a composition for light diffusion control unit that contains a high refractive index component and a low refractive index component having a refractive index lower than that of the high refractive index component. In particular, each of the high refractive index component and the low refractive index component may preferably have one or two polymerizable functional groups.

### (1) High Refractive Index Component

Preferred examples of the high refractive index component include (meth)acrylic ester that contains an aromatic ring, and (meth)acrylic ester that contains a plurality of aromatic rings may be particularly preferred. Examples of (meth)acrylic ester that contains a plurality of aromatic rings include those in which a part thereof is substituted with halogen, alkyl, alkoxy, alkyl halide, or the like, such as biphenyl (meth)acrylate, naphthyl (meth)acrylate, anthracyl (meth)acrylate, benzylphenyl (meth)acrylate, biphenyloxyalkyl (meth)acrylate, naphthyloxyalkyl (meth)acrylate, anthracyloxyalkyl benzylphenyloxyalkyl (meth)acrylate. (meth)acrylate, and Among these, biphenyl (meth)acrylate may be preferred from the viewpoint of easily forming a good regular internal structure. Specifically, o-phenylphenoxyethyl acrylate, o-phenylphenoxyethoxyethyl acrylate, or the like may be preferred. In the present specification, (meth)acrylic acid means both the acrylic acid and the methacrylic acid. The same applies to other similar terms.

The molecular weight of the high refractive index component may be preferably 150 to 2, 500, particularly preferably 200 to 1,500, and further preferably 250 to 1,000. When the molecular weight falls within the above range, the light diffusion control unit 2 having a desired regular internal structure can be easily formed. When the theoretical molecular weight of the above high refractive index component can be specified based on the molecular structure, the molecular weight of the high refractive index component refers to the theoretical molecular weight. On the other hand, when it is difficult to specify the above-described theoretical molecular weight due to the above high refractive index component being a polymer component, for example, the molecular weight of the high refractive index component refers to a weight-average molecular weight obtained as a standard polystyrene-equivalent value that is measured using a gel permeation chromatography (GPC) method. As used in the present specification, the weight-average molecular weight refers to a value that is measured as the standard polystyrene equivalent value using the GPC method.

The refractive index of the high refractive index component may be preferably 1.45 to 1.70, more preferably 1.50 to 1.65, particularly preferably 1.54 to 1.62, and further preferably 1.56 to 1.59. When the refractive index falls within the above range, the light diffusion control unit 2 having a desired regular internal structure can be easily formed. As used in the present specification, the refractive index means the refractive index of a certain component before curing the composition for light diffusion control unit, and the refractive index is measured in accordance with JIS K0062: 1992.

The content of the high refractive index component in the composition for light diffusion control unit may be preferably 25 to 400 mass parts, more preferably 50 to 350 mass parts, particularly preferably 75 to 300 mass parts, and further preferably 100 to 200 mass parts with respect to 100 mass parts of the low refractive index component. When the content falls within the above range, the regions derived from the high refractive index component and the region derived from the low refractive index component exist with a desired ratio in the regular internal structure of the light diffusion control layer 11 formed, so that a desired regular internal structure can be easily formed.

### (2) Low Refractive Index Component

Preferred examples of the low refractive index component include urethane (meth)acrylate, a (meth)acrylic-based polymer having a (meth)acryloyl group in a side chain, a (meth)acryloyl group-containing silicone resin, and an unsaturated polyester resin. Among them, it may be particularly preferred to use urethane (meth)acrylate from the viewpoint that a good regular internal structure can be easily formed. More specifically, it may be preferred to use urethane (meth)acrylate that is formed of (a) a compound containing at least two isocyanate groups, (b) polyalkylene glycol, and (c) hydroxyalkyl (meth)acrylate.

Preferred examples of the above-described (a) compound containing at least two isocyanate groups include aromatic polyisocyanates such as 2,4-tolylene diisocyanate, 2,6-tolylene diisocyanate, 1,3-xylylene diisocyanate, and 1,4-xylylene diisocyanate, aliphatic polyisocyanates such as hexamethylene diisocyanate, alicyclic polyisocyanates such as isophorone diisocyanate and hydrogenated diphenylmethane diisocyanate, biuret bodies and isocyanurate bodies thereof, and adduct bodies that are reaction products with low molecular active hydrogen-containing compounds such as ethylene glycol, propylene glycol, neopentyl glycol, trimethylol propane, and castor oil. Among these, an alicyclic polyisocyanate may be preferred, and an alicyclic diisocyanate may be particularly preferred.

Preferred examples of the above-described (b) polyethylene glycol, polyalkylene glycol include polypropylene glycol, polybutylene glycol, and polyhexylene glycol, among which polypropylene glycol may be preferred. The weight-average molecular weight of the (b) polyalkylene glycol may be preferably 2,300 to 19, 500, particularly preferably 3,000 to 14,300, and further preferably 4,000 to 12,300.

Preferred examples of the above-described (c) hydroxyalkyl (meth)acrylate include 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, and 4-hydroxybutyl (meth)acrylate, among which 2-hydroxyethyl (meth)acrylate may be preferred.

Synthesis of the urethane (meth)acrylate using the above-described components (a) to (c) as the materials can be performed in a commonly-used method. In such a method, from the viewpoint of efficiently synthesizing the urethane (meth)acrylate, the compounding ratio of the components (a), (b), and (c) as the molar ratio may be preferably a ratio of 1-5:1:1-5 and particularly preferably a ratio of 1-3:1:1-3.

The weight-average molecular weight low of the refractive index component may be preferably 3,000 to 20,000, particularly preferably 5,000 to 15,000, and further preferably 7,000 to 13,000. When the weight-average molecular weight falls within the above range, the light diffusion control unit 2 having a desired regular internal structure can be easily formed.

The refractive index of the low refractive index component may be preferably 1.30 to 1.59, more preferably 1.38 to 1.50, particularly preferably 1.42 to 1.49, and further preferably 1.46 to 1.48. When the refractive index falls within the above range, the light diffusion control unit 2 having a desired regular internal structure can be easily formed.

### (3) Other Additives

The aforementioned composition for light diffusion control unit may contain other additives in addition to the high refractive index component and the low refractive index component. Examples of other additives include a multifunctional monomer, a photopolymerization initiator, an antioxidant, an ultraviolet absorber, a light stabilizer, an antistatic, a polymerization accelerator, a polymerization inhibitor, an infrared absorber, a plasticizer, a diluting solvent, and a leveling agent.

The composition for light diffusion control unit may preferably contain a photopolymerization initiator among the above. This allows the light diffusion control unit 2 having a desired regular internal structure to be easily and efficiently formed.

Examples of the photopolymerization initiator include benzoin, benzoin methyl ether, benzoin ethyl ether, benzoin isopropyl ether, benzoin-n-butyl ether, benzoin isobutyl ether, acetophenone, dimethylaminoacetophenone, 2,2-dimethoxy-2-phenylacetophenone, 2,2-diethoxy-2-phenylacetophenone, 2-hydroxy-2-methyl-1-phenylpropan-1-one, 1-hydroxycyclohexyl phenyl ketone, 2-methyl-1-[4-(methylthio)phenyl]-2-morpholino-propan-1-one, 4-(2-hydroxyethoxy)phenyl-2-(hydroxy-2-propyl) ketone, benzophenone, p-phenylbenzophenone, 4,4-diethylaminobenzophenone, dichlorobenzophenone, 2-methylanthraquinone, 2-ethylanthraquinone, 2-tert-butylanthraquinone, 2-aminoanthraquinone, 2-methylthioxanthone, 2-ethylthioxanthone, 2-chlorothioxanthone, 2,4-dimethylthioxanthone, 2,4-diethylthioxanthone, benzyl dimethyl ketal, acetophenone dimethyl ketal, p-dimethylaminebenzoic ester, and oligo [2-hydroxy-2-methyl-1-[4-(1-methylvinyl)phenyl] propane]. These may each be used alone, or two or more types may also be used in combination.

When the photopolymerization initiator is used, the content of the photopolymerization initiator in the composition for light diffusion control unit may be preferably 0.2 to 20 mass parts or 0.5 to 16 mass parts, particularly preferably 1 to 13 mass parts, and further preferably 1 to 10 mass parts with respect to 100 mass parts of the total amount of the high refractive index component and the low refractive index component. When the content falls within the above range, the light diffusion control unit 2 having a desired regular internal structure can be easily and efficiently formed.

### (4) Preparation of Composition for Light Diffusion Control Unit

The composition for light diffusion control unit can be prepared by uniformly mixing the aforementioned high refractive index component and low refractive index component and, if desired, other additives such as a photopolymerization initiator and an ultraviolet absorber.

In the above mixing, a uniform composition for light diffusion control unit may be obtained by stirring it while heating it to a temperature of 40° C. to 80° C. A diluting solvent may be added and mixed so that the obtained composition for light diffusion control unit has a desired viscosity.

### (5) Regular Internal Structure

As described previously, the light diffusion control unit 2 preferably has a louver-shaped regular internal structure that includes a plurality of plate-shaped regions 201 having a relatively high refractive index in a region 202 having a relatively low refractive index.

As illustrated in FIG. 2, in the light diffusion control unit 2, each of the plate-shaped regions 201 may be preferably tilted toward the first direction D1 within the light diffusion control unit 2. This allows the aerial image forming device 10 according to the present embodiment to readily suppress the occurrence of a ghost image and to display the aerial image more brightly.

When the plate-shaped regions 201 are tilted as described above, the angle of tilt may be preferably 0° or more, more preferably 1° or more, particularly preferably 2° or more, and further preferably 3° or more with respect to the thickness direction of the light diffusion control unit 2. From another aspect, the above angle may be preferably 30° or less, more preferably 28° or less, particularly preferably 25° or less, further preferably 20° or less, and especially preferably 10° or less. When the plate-shaped regions 201 are tilted at these angles, the aerial image forming device 10 according to the present embodiment can readily suppress the occurrence of a ghost image and can readily display the aerial image more brightly.

The light diffusion control unit 2 may have a structure other than the regular internal structure illustrated in FIG. 2. For example, the plate-shaped regions 201 may be bent at the middle in the thickness direction of the light diffusion control unit 2. The light diffusion control unit 2 may also be formed by laminating two or more layers of regular internal structures in which the plate-shaped regions 201 are arranged.

### (6) Thickness of Light Diffusion Control Unit

The thickness of the light diffusion control unit 2 may be preferably 1 to 500 μm, more preferably 10 to 300 μm, particularly preferably 50 to 250 μm, further preferably 80 to 200 μm, and especially preferably 100 to 160 μm. When the thickness falls within the above range, the aerial image forming device 10 according to the present embodiment can readily suppress the occurrence of a ghost image and can readily display the aerial image more brightly.

### (7) Method of Forming Light Diffusion Control Unit

The method of forming the light diffusion control unit 2 is not particularly limited, and it can be formed by a conventionally known method.

For example, one surface of a process sheet may be coated with the aforementioned composition for light diffusion control unit to form a coating film, and one surface of a release sheet (in particular, the release surface) is then attached to the surface of the coating film opposite to the process sheet. Subsequently, the above coating film is irradiated with active energy rays via the process sheet or the release sheet to cure the coating film, and the light diffusion control unit 2 can thereby be formed. Thus, by laminating the release sheet on the above coating film, the light diffusion control unit 2 having a uniform thickness and a regular internal structure can readily be formed while maintaining the gap between the release sheet and the process sheet and suppressing the crushing of the coating film.

Examples of the above release sheet for use include resin films such as a polyethylene film, a polypropylene film, a polybutene film, a polybutadiene film, a polymethylpentene film, a polyvinyl chloride film, a vinyl chloride copolymer film, a polyethylene terephthalate film, a polyethylene naphthalate film, a polybutylene terephthalate film, a polyurethane film, an ethylene vinyl acetate film, an resin ionomer film, an ethylene-(meth)acrylic acid copolymer film, an ethylene-(meth)acrylic ester copolymer film, a polystyrene film, a polycarbonate film, a polyimide film, and a fluorine resin film. Crosslinked films thereof may also be used. Laminate films each obtained by laminating a plurality of such films may also be used.

It may be preferred to perform release treatment for the release surface of the release sheet. Preferred examples of a release agent to be used for the release treatment include alkyd-based, silicone-based, fluorine-based, unsaturated polyester-based, polyolefin-based, and wax-based release agents.

The thickness of the release sheet is not particularly limited, but from the viewpoints of excellent handling properties and satisfactory protection of the light diffusion control unit until its use, it may be preferably 20 to 200 μm and more preferably 30 to 100 μm.

The resin film, crosslinked film, or laminated film thereof used as the above-described release sheet can be used as the above process sheet. The above-described release sheet can also be used as the process sheet.

The thickness of the process sheet may be preferably 20 to 250 μm and more preferably 30 to 200 μm from the viewpoints that the desired light diffusion control unit can be readily formed and that the light diffusion control unit can be well protected until its use.

Examples of the method for the above-described coating include a knife coating method, a roll coating method, a bar coating method, a blade coating method, a die coating method, and a gravure coating method. The composition for light diffusion control unit may be diluted using a solvent as necessary.

Irradiation with active energy rays for the coating film may be performed by a conventionally known method. For example, a linear light source may be used as the light source for active energy rays, and the surface of the irradiation target may be irradiated with light in a band-like (almost linear) shape that is random in the width direction (TD direction) and approximately parallel in the flow direction (MD direction). By adjusting the irradiation angle of the above light, the tilt angle of the plate-shaped regions 201 can also be adjusted.

The above active energy rays refer to electromagnetic wave or charged particle radiation having an energy quantum, and specific examples of the active energy rays include ultraviolet rays and electron rays. Among the active energy rays, ultraviolet rays may be particularly preferred because of easy management and easy formation of a desired regular internal structure.

When using ultraviolet rays as the active energy rays, it may be preferred to set the irradiation condition such that the peak illuminance on the coating film surface is 0.1 to 200 mW/cm². Additionally or alternatively, it may be preferred to set the integrated light amount on the coating film surface to 5 to 300 mJ/cm². The relative moving speed of the light source for active energy rays with respect to the irradiation target may be preferably 0.1 to 10 m/min.

From the viewpoint of completing more reliable curing, it may also be preferred to perform the irradiation with commonly-used active energy rays (active energy rays for which the process of converting the rays into parallel light or strip-shaped light is not performed, scattered light) after performing the curing using the strip-shaped light as previously described.

### 3. Light-Transmitting Image Formation Unit

The light-transmitting image formation unit 3 constituting the aerial image forming device 10 according to the present embodiment is not particularly limited, provided that it can transmit the light originating from and form an aerial image on a the display unit 1 predetermined aerial image observation surface. Examples of such a light-transmitting image formation unit 3 include a retro-transmitting optical element that retro-transmits incident light.

As the retro-transmitting optical element, a conventionally known one can be used, but from the viewpoint of facilitating good aerial image formation, it may be preferred to use a retro-transmitting optical element having a dihedral corner reflector array structure, a retro-transmitting optical element configured such that two layers each having a plurality of reflective surfaces are laminated, etc., and it may be more preferred to use a retro-transmitting optical element configured such that two layers each having a plurality of reflective surfaces are laminated. In particular, the retro-transmitting optical element may be preferably configured such that, in each of the above two layers, the plurality of reflective surfaces are arranged perpendicular to one surface of the retro-transmitting optical element and at a predetermined distance from each other, and the above two layers are laminated so that the above reflective surfaces in one layer of the above two layers are perpendicular to the above reflective surfaces in the other layer of the two layers.

The thickness of the light-transmitting image formation unit 3 may be preferably 0.1 to 20 mm, more preferably 0.5 to 15 mm, particularly preferably 1 to 12 mm, further preferably 2 to 10 mm, and especially preferably 4 to 8 mm. When the thickness of the light-transmitting image formation unit 3 falls within the above range, the aerial image forming device 10 according to the present embodiment can readily suppress the occurrence of a ghost image and can readily display the aerial image more brightly.

### 4. Other Components

The aerial image forming device 10 according to the present embodiment may include components other than the above-described display unit 1, light diffusion control unit 2, and light-transmitting image formation unit 3. In particular, the aerial image forming device 10 according to the present embodiment may preferably include a housing for fixing and housing the display unit 1, light diffusion control unit 2, and light-transmitting image formation unit 3 in predetermined positions.

The material, shape, dimensions, etc. of the housing can be appropriately selected depending on the application and purpose. In particular, the housing may be preferably formed of a light-blocking material, which can prevent the light originating from unit the display 1 from unintentionally leaking to the outside and can prevent unintentional intrusion of external light into the optical path from the display unit 1 to the light diffusion control unit 2.

### 5. Positional Relationship of Each Element

In the aerial image forming device 10 according to the present embodiment, when the first direction indicated by “D1” in FIG. 1 is assumed and a direction parallel to a plane perpendicular to both the display surface of the display unit 1 and one surface of the light diffusion control unit 2 and existing in the surface of the light diffusion control unit 2 opposite to the light-transmitting image formation unit 3 is assumed as the second direction, an acute angle formed between the first direction and the second direction may be preferably 0° or more and 90° or less. Regardless of the above acute angle, by taking account of the incident angle on the light diffusion control unit 2 in a plane that includes D1 and is perpendicular to the light diffusion control unit 2, the aerial image forming device 10 according to the present embodiment can readily suppress the occurrence of a ghost image and can readily display an aerial image more brightly.

Additionally or alternatively, when the aerial image forming device 10 according to the present embodiment includes, as the light-transmitting image formation unit 3, the aforementioned retro-transmitting optical element having a dihedral corner reflector array structure or retro-transmitting optical element configured such that two layers each having a plurality of reflective surfaces are laminated, it is also preferred to satisfy the following conditions.

First, as a premise, a plane F is assumed that is perpendicular to both the surface of the light-transmitting image formation unit 3 opposite to the light diffusion control unit 2 and the display surface of the display unit 1 and that passes through the center point of the light-transmitting image formation unit 3. In addition, a width of the light-transmitting image formation unit 3 in a cross section obtained by cutting the light-transmitting image formation unit 3 at the plane F is defined as a width W.

Furthermore, an observation point is assumed that exists within the plane F and satisfies both the following conditions A and B:
(Condition A)
when an angle between a line segment connecting the above observation point and the above center point and the surface of the light-transmitting image formation unit 3 opposite to the light diffusion control unit 2 is angle α, and an angle between a plane including the display surface of the display unit 1 and a plane including the surface of the light-transmitting image formation unit 3 opposite to the light diffusion control unit 2 is angle β, the total of the angles α and β is 90°; and
(Condition B)
a distance between the above observation point and the above center point is 1 to 10 times the width W.

As additional information, the above condition A means that the position of the observation point is determined depending on the positional relationship between the display unit 1 and the light-transmitting image formation unit 3 in the aerial image forming device 10. For example, for the aerial image forming device 10 in which the display unit 1 and the light-transmitting image formation unit 3 are arranged so that the angle β s 45°, the above condition A means that the angle α relating to the observation point is 45°, and for the aerial image forming device 10 in which the angle β is 60°, the above condition A means that the angle α relating to the observation point is 30°.

Regarding the above condition B, the expression that “a distance . . . is 1 to 10 times the width W” means that the above observation point only needs to satisfy the condition for any one point within this range. In particular, the condition B may be preferably that “the distance between the above observation point and the above center point is 3.5 times the width W.”

Then, each element of the aerial image forming device 10 may be preferably configured such that when the aerial image forming device 10 is observed from the observation point, the light diffusion control unit 2 simultaneously satisfies the following two conditions:
(Condition 1)
in the light that is emitted from any one point on the display unit 1 and reaches the observation point, light that is reflected by both of the two layers constituting the retro-transmitting optical element gives a haze value of 60% or less; and
(Condition 2)
in the light that is emitted from any one point on the display unit 1 and reaches the observation point, light that is reflected by only one of the two layers constituting the retro-transmitting optical element gives a haze value of 60% or more.

By satisfying the above conditions, the aerial image forming device 10 according to the present embodiment can readily suppress the occurrence of a ghost image and can readily display the aerial image more brightly.

Here, the phenomenon that “light is reflected by both of the two layers” or “light is reflected by only one of the two layers” means reflection in the sense of changing the direction of travel, rather than physical reflection. In the retro-transmitting optical element configured such that two layers each having a plurality of reflective surfaces are laminated, parallel mirror surfaces are arranged in each layer, so that the direction of travel is changed by an odd number of reflections, and the direction of travel is not changed by an even number of reflections. In the above phrase, “light is reflected” can be rephrased as “light is reflected an odd number of times and the direction of travel is changed.”

### 6. Physical Properties of Aerial Image Forming Device

In the aerial image forming device 10 according to the present embodiment, the luminance measured when the entire surface of the display unit 1 is displayed in white may be preferably 1 to 1,000 cd/m², more preferably 3 to 500 cd/m², particularly preferably 5 to 100 cd/m², further preferably 7 to 50 cd/m², especially preferably 9 to 30 cd/m², and most preferably 10 to 15 cd/m². When the luminance of the white display falls within the above range, the aerial image can be visually recognized better.

From another aspect, in the aerial image forming device 10 according to the present embodiment, the luminance measured when the entire surface of the display unit 1 is displayed in black may be preferably 0.01 to 10 cd/m², more preferably 0.05 to 5 cd/m², particularly preferably 0.10 to 1 cd/m², further preferably 0.15 to 0.50 cd/m², and especially preferably 0.20 to 0.30 cd/m². When the luminance of the black display falls within the above range, the contrast ratio may be readily improved, and the aerial image can be visually recognized better.

Details of the method of measuring the luminance in the above-described white and black displays are as described in the testing example, which will be described later.

Furthermore, in the aerial image forming device 10 according to the present embodiment, the contrast ratio calculated from the brightness of the white display and the brightness of the black display described above may be preferably 1 to 10,000, more preferably 10 to 5,000, particularly preferably 20 to 1,000, further preferably 30 to 500, and especially preferably 40 to 100. When the contrast ratio falls within the above range, the aerial image can be visually recognized better.

### 7. Method for Manufacturing Aerial Image Forming Device

The method for manufacturing the aerial image forming device 10 according to the present embodiment is not particularly limited. For example, after the display unit 1, the light diffusion control unit 2, and the light-transmitting image formation unit 3 are prepared, the aerial image forming device 10 can be obtained through installing the display unit 1 at a predetermined position in the housing and installing a laminate of the light diffusion control unit 2 and the light-transmitting image formation unit 3.

### 8. Method of Using Aerial Image Forming Device

The aerial image forming device 10 according to the present embodiment can be used as a display device for displaying any image or video in the air. Specific method of using the aerial image forming device 10 is not limited, and it can be used in the same manner as in the conventionally known display devices.

In the present specification, unless otherwise specified, the statement of “X to Y” (X and Y are arbitrary numbers) encompasses not only the meaning of “X or more and Y or less” but also the meaning of “preferably more than X” or “preferably less than Y.” In addition, unless otherwise specified, the statement of “X or more” (X is an arbitrary number) encompasses the meaning of “preferably more than X,” and the statement of “Y or less” (Y is an arbitrary number) encompasses the meaning of “preferably less than Y.”

It should be appreciated that the aforementioned embodiments are described to facilitate understanding of the present invention and are not described to limit the present invention. It is therefore intended that the elements disclosed in the above embodiments include all design changes and equivalents to fall within the technical scope of the present invention.

### EXAMPLES

Hereinafter, the present invention will be described further specifically with reference to examples, etc., but the scope of the present invention is not limited to these examples, etc.

### Example 1

### 1. Preparation of Composition for Light Diffusion Control Unit

Polyether urethane methacrylate having a weight-average molecular weight of 9,900 was obtained as the low refractive index component by reacting polypropylene glycol, isophorone diisocyanate, and 2-hydroxyethyl methacrylate. A composition for light diffusion control unit was obtained through adding 60 mass parts (solid content equivalent value, here and hereinafter) of o-phenylphenoxyethoxyethyl acrylate having a molecular weight of 268 as the high refractive index component and 8 mass parts of 2-hydroxy-2-methyl-1-phenylpropan-1-one as the photopolymerization initiator to 40 mass parts of the above low refractive index component and then heating and mixing them under a condition of 80° C.

Here, the aforementioned weight-average molecular weight (Mw) refers to a weight-average molecular weight that is measured as a standard polystyrene equivalent value under the following condition using gel permeation chromatography (GPC) (GPC measurement).

### «Measurement Conditions»

Measurement device: HLC-8320 available from Tosoh Corporation
GPC columns (passing through in the following order): available from Tosoh Corporation
   TSK gel super H-H
   TSK gel super HM-H
   TSK gel super H2000
Solvent for measurement: tetrahydrofuran
Measurement temperature: 40° C.

### 2. Formation of Light Diffusion Control Unit

The release surface of a release sheet as a process sheet (available from LINTEC Corporation, product name “SP-PET381130,” thickness: 38 μm) obtained by release-treating one surface of a polyethylene terephthalate film with a silicone-based release agent was coated with the obtained composition for light diffusion control unit to form a coating film. A laminate composed of the coating film and the process sheet was thus obtained. Subsequently, the release surface of a release sheet (available from LINTEC Corporation, product name “SP-PET381130,” thickness: 38 μm) obtained by release-treating one surface of a polyethylene terephthalate film with a silicone-based release agent was laminated on the surface of the laminate on the coating film side. Thus, a laminate was obtained in which the process sheet, the above coating film, and the release sheet were laminated in this order.

Subsequently, the laminate obtained was placed on a conveyor. At that time, the surface of the release sheet in the laminate was set on the upper side, and the longitudinal direction of the process sheet and release sheet was set parallel to the flow direction of the conveyor. Then, an ultraviolet irradiation apparatus (available from EYE GRAPHICS CO., LTD., product name “ECS-4011GX”) having a linear high-pressure mercury lamp with a cold mirror for light concentration was installed on the conveyor on which the laminate was placed. This apparatus can irradiate an object with ultraviolet rays concentrated in a strip shape (approximately shape). Upon installation of the above ultraviolet irradiation apparatus, it was installed so that the longitudinal direction of the above high-pressure mercury lamp and the flow direction of the conveyor were orthogonal to each other.

When viewed from the longitudinal direction of the high-pressure mercury lamp, the irradiation angle of the ultraviolet rays emitted from the high-pressure mercury lamp to the laminate was set to 5° with reference to the normal to the surface of the laminate. The irradiation angle referred to herein is described as a positive value of the acute angle formed between the normal to the surface f the laminate and the ultraviolet rays when the ultraviolet rays are emitted toward the downstream side of the flow of the conveyor with reference to the position of the laminate just below the high-pressure mercury lamp while described as a negative value of the acute angle formed between the normal to the surface of the laminate and the ultraviolet rays when the ultraviolet rays are emitted toward the upstream side of the flow of the conveyor.

After that, while the conveyor was operated to move the above laminate at a speed of 1.0 m/min, the coating film in the laminate was cured by being irradiated with ultraviolet rays through the above release sheet under the conditions of a peak illuminance of 2.5 mW/cm² and an integrated light amount of 40.0 mJ/cm² on the coating film surface (this curing may be referred to as “primary curing” for descriptive purposes).

Subsequently, while being moved at a speed of 1.0 m/min, the coating film was irradiated with ultraviolet rays (scattered light) through the release sheet under conditions of a peak illuminance of 190 mW/cm² and an integrated light amount of 180 mJ/cm², thereby curing the coating film in the laminate (this curing may be referred to as “secondary curing” for descriptive purposes). The above-described peak illuminance and integrated light amount were measured using a UV METER (available from EYE GRAPHICS CO., LTD., product name “EYE Ultraviolet Integrated Illuminance Meter UVPF-A1”) equipped with a light receiver and installed for the position of the above coating film.

Through the above primary curing and secondary curing, the above-described coating film was sufficiently cured to form a light diffusion control layer. Thus, a laminate was obtained in which the process sheet, the light diffusion control unit having a thickness of 140 μm, and the release sheet were laminated in this order.

When microscopic observation and the like of the cross section of the formed light diffusion control unit were performed, it was confirmed that a louver structure was formed inside the light diffusion control unit such that, as illustrated in FIG. 2, a plurality of plate-shaped regions 201 were arranged in parallel at predetermined intervals. The acute angle formed between the main surface of the louver structure and the normal to the light diffusion control unit was 3.3°.

### 3. Formation of Aerial Image Forming Device

The release sheet was removed from the laminate obtained as described above, and the exposed surface of the light diffusion control unit was laminated on one surface of a retro-transmitting optical element, as the light-transmitting image formation unit, (available from Asukanet Co., Ltd., product name “ASKA3D-200NT,” 200 mm long×200 mm wide×6.3 mm thick) configured such that two layers each including a plurality of reflective surfaces were laminated.

Then, the obtained laminate of the light diffusion control unit and the light-transmitting image formation unit was installed in a given housing so that the main surface of the laminate would be horizontal and the surface on the light diffusion control unit side would face downward. Furthermore, as the display unit, the screen of a laptop computer was installed in the housing so that it would face the laminate of the light diffusion control unit and the light-transmitting image formation unit.

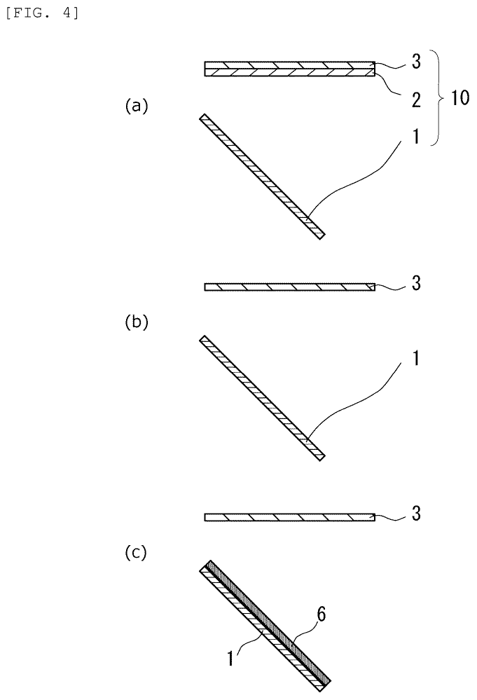

When the above display unit was installed, the angle between the display surface of the display unit 1 and the main surface of the light diffusion control unit 2 was set to 45°, as illustrated in FIG. 4(a). The display unit was installed so that the angle between the first direction (direction perpendicular to the longitudinal direction of the plate-shaped regions and existing in the surface of the light diffusion control unit opposite to the light-transmitting image formation unit, D1 in FIG. 2) and the second direction (direction parallel to the plane perpendicular to both the display surface and one surface of the light diffusion control unit and existing in the surface of the light diffusion control unit opposite to the light-transmitting image formation unit) would be 0°.

The above housing is light-blocked so that the light emitted from the display unit does not exit to the outside from anywhere other than the light diffusion control unit and the light-transmitting image formation unit.

As a result of the above, the aerial image forming device 10 was obtained in which, as illustrated in FIG. 4(a), the light-transmitting image formation unit 3, the light diffusion control unit 2, and the display unit 1 were arranged in the housing.

### Example 2

An aerial image forming device was obtained in the same manner as in Example 1 except that a commercially available light diffusion control film (available from LINTEC Corporation, product name “WINCOS Z-2555”) was used as the light diffusion control unit 2 and the angle between the first direction and the second direction was set to 90°. That is, the aerial image forming device 10 was obtained in which, as illustrated in FIG. 4(a), the light-transmitting image formation unit 3, the light diffusion control unit 2, and the display unit 1 were arranged in the housing.

The above commercially light diffusion control film is a two-layer laminate of layers each including a louver structure in which, as illustrated in FIG. 2, the plurality of plate-shaped regions 201 are arranged in parallel at a predetermined interval. The two layers are laminated so that the tilt directions of the louver structures are opposite to each other. The acute angle formed between the main surface of the louver structure and the normal to the light diffusion control unit was −27° for one layer and +27° for the other layer.

### Example 3

An aerial image forming device was obtained in the same manner as in Example 1 except that a retro-transmitting optical element (available from Parity Innovations Co. Ltd., product name “Parity Mirror,” 300 mm long×300 mm wide×2 mm thick) having a dihedral corner reflector array structure on a resin plate was used as the light-transmitting image formation unit and the light diffusion control unit was laminated on the resin plate surface on which the dihedral corner reflector array structure was not disposed in the retro-transmitting optical element. The aerial image forming device 10 was thus obtained in which, as illustrated in FIG. 4(a), the light-transmitting image formation unit 3, the light diffusion control unit 2, and the display unit 1 were arranged in the housing.

### Comparative Example 1

An aerial image forming device was obtained in the same manner as in Example 1 except that no light diffusion control unit was used. That is, an aerial image forming device was obtained in which, as illustrated in FIG. 4(b), the light-transmitting image formation unit 3 and the display unit 1 were arranged in the housing.

### Comparative Example 2

An aerial image forming device was obtained in the same manner as in Example 1 except that no light diffusion control unit was used and a component in which a privacy film (available from 3M Company, product name “PF12.1WH2”) was attached to the screen of a laptop computer was used. The above privacy film blocks specific light so that the effective viewing angle in the right-left direction is narrowed to within 48°, and was attached to the display unit so that the viewing angle control direction would be perpendicular to the second direction (in FIG. 4(c) so that it would be the depth direction of the paper). An aerial image forming device was thus obtained in which, as illustrated in FIG. 4(c), the light-transmitting image formation unit 3, the privacy film 6, and the display unit 1 are arranged in the housing.

### Comparative Example 3

An aerial image forming device was obtained in the same manner as in Example 3 except that no light diffusion control unit was used. That is, an aerial image forming device was obtained in which, as illustrated in FIG. 4(b), the light-transmitting image formation unit 3 and the display unit 1 were arranged in the housing.

### Comparative Example 4

An aerial image forming device was obtained in the same manner as in Example 3 except that no light diffusion control unit was used and a component in which a privacy film (available from 3M Company, product name “PF12.1WH2”) was attached to the screen of a laptop computer was used. The above privacy film was attached to the display unit so that the viewing angle control direction would be perpendicular to the second direction. An aerial image forming device was thus obtained in which, as illustrated in FIG. 4(c), the light-transmitting image formation unit 3, the privacy film 6, and the display unit 1 are arranged in the housing.

### <Testing Example 1> (Confirmation of Relationship Between Specific Angles in Aerial Image Forming Device)

(1) Identification of Incident Angle Range of Light that forms Aerial Image and Ghost Image

As in Comparative Example 1, an aerial image forming device was prepared in which the light-transmitting image formation unit and the display unit were arranged inside the housing (without a light diffusion control unit or privacy film). For the aerial image forming device, an image measuring 70 mm in height and 100 mm in width was displayed on the display surface of the display unit. It was visually confirmed that an aerial image and a ghost image occurred.

Here, the position (observation point) of the viewer when confirming the above-described aerial image was as follows. First, the plane F was assumed that was perpendicular to both the surface of the light-transmitting image formation unit on the display unit side and the display surface of the display unit and that passed through the center point of the light-transmitting image formation unit. Furthermore, the width of the light-transmitting image formation unit in a cross section obtained by cutting the light-transmitting image formation unit at the plane F was set to width W (specifically, 200 mm). Then, a point that exists within the plane F and satisfies both of the aforementioned Condition A and Condition B was set as the observation point. Here, regarding Condition A, since the angle β related to the prepared aerial image forming device is 45°, the angle α is 45°. Furthermore, the magnification regarding Condition B was selected to be 3.5 times (i.e., the distance between the observation point and the above center point was set to 3.5 times the width W).

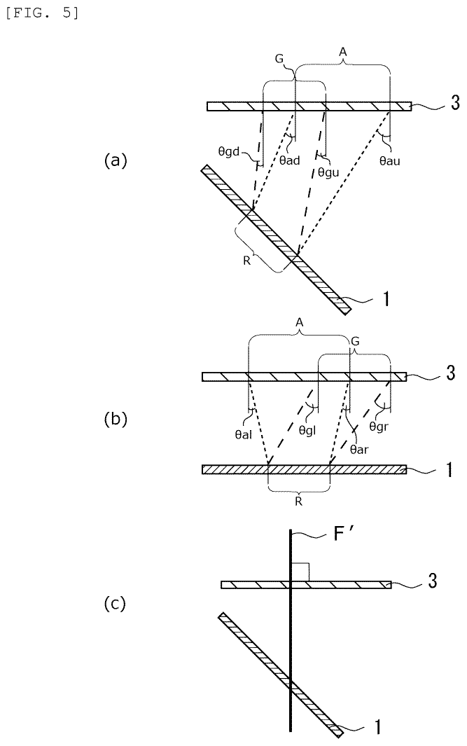

Subsequently, on the basis of the visually confirmed aerial image and ghost image, the area in the light-transmitting image formation unit through which, in the light emitted from the display unit, light that formed these images passed was identified. Here, FIG. 5(a) illustrates a cross-sectional view of the light-transmitting image formation unit 3 and display unit 1 seen from the side surfaces (cross-sectional view cut at the above-described plane F). FIG. 5(b) illustrates a cross-sectional view of the light-transmitting image formation unit 3 and display unit 1 cut at the plane indicated by symbol F′ in FIG. 5(c). The plane indicated by the symbol F′ is a plane perpendicular to both the above-described plane F and one surface of the light-transmitting image formation unit 3. In the following description, when discussing the image illustrated in FIG. 5(a), it may be expressed as an image in the “front-rear direction,” and when discussing the image illustrated in FIG. 5(b), it may be expressed as an image in the “right-left direction.”

In FIGS. 5(a) and 5(b), the area indicated by “R” is an area in which the real image is displayed on the display unit 1. The area indicated by “A” is an area through which the light that forms the aerial image passes. The area indicated by “G” is an area through which the light that forms the ghost image passes. Note that when a cross section cut by the plane F′ is viewed, two ghost images occur in general symmetrically on the right and left of the aerial image, but it is sufficient to consider only one of them, so FIG. 5(b) illustrates only one of them (only the ghost image on the right).

In the light that forms the aerial image, the paths of light that is emitted from the ends of area R and reaches the ends of area A (line segments connecting the ends of area R and the ends of area A in FIGS. 5(a) and 5(b)) were identified. Likewise, in the light that forms the ghost image, the paths of light that is emitted from the ends of area R and reaches the ends (line segments connecting the ends of area R and the ends of area G in FIGS. 5(a) and 5(b)) were identified.

Then, the acute angles formed by these line segments and the normal to one surface of the light-transmitting image formation unit 3 (various angles indicated by symbols including “θ” in FIGS. 5(a) and 5(b)) were measured. The results are listed in Table 1. Note that the angles in Table 1 are expressed with a negative sign for acute angles on the left side of the paper in FIGS. 5(a) and 5(b) with respect to the normal, and with a positive sign for acute angles on the right side of the paper.

TABLE 1

| Acute angle | | Angle (°) |
|---|---|---|
| FIG. 5(a) | θ au | −41.9 |
| Front-rear | θ ad | −37.1 |
| direction | θ gu | −4.9 |
| | θ gd | −3.1 |
| FIG. 5(b) | θ ar | −8.4 |
| Right-left | θ al | 8.4 |
| direction | θ gr | −36.6 |
| | θ gl | −36.6 |

From the above, it can be found that the light for forming the aerial image emitted from any one point on the reaches the light-transmitting image display surface formation unit within an incident range of θau to θad in front-rear direction, and the reaches the light-transmitting image formation unit within an incident range of θar to θal in the right-left direction. It can also be found that the light for forming the ghost image emitted from any one point on the display surface reaches the light-transmitting image formation unit in an incident range of θgu to θgd in the front-rear direction, and reaches the light-transmitting image formation unit within an incident range of θgr to θgl in the right-left direction.

### (2) Measurement of Variable Angle Haze

For the light diffusion control unit used in each of Examples 1 and 2, the haze value (%) was measured using a variable haze meter (available from Toyo Seiki Seisaku-sho, Ltd., product name “Haze-Gard-Plus, Variable Haze Meter”).

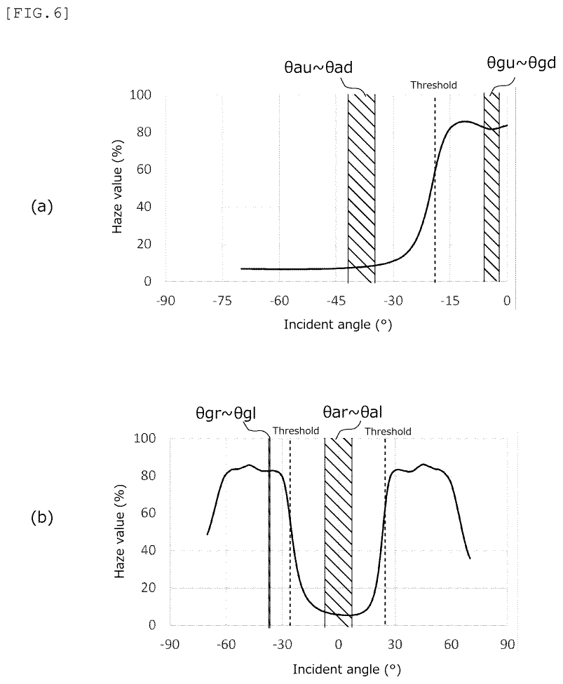

Specifically, for Example 1, one surface of the light diffusion control unit was irradiated with light rays while varying the incident angle with respect to the normal to the one surface in a range of −90° to 0° along the front-rear direction identified in the above step (1), and the haze value (%) was measured in sequence. The results are illustrated in FIG. 6(a).

Also for Example 2, one surface of the light diffusion control unit was irradiated with light rays while varying the incident angle with respect to the normal to the one surface in a range of −90° to 90° along the right-left direction identified in the above step (1), and the haze value (%) was measured in sequence. The results are illustrated in FIG. 6(b).

In each of FIGS. 6(a) and 6(b), the curved graph illustrates the change in haze value with the change in incident angle.

### (3) Confirmation of Relationship Between Incident Range and Variable Angle Haze

The incident ranges of light related to the aerial image and ghost image identified in the above step (1) were superimposed on the measurement results of the above step image forming device of (2). That is, for the aerial Example 1, FIG. 6(a) illustrates as shaded areas an incident range of θau to Oad when the light forming the aerial image is incident on the light-transmitting image formation unit (and the light diffusion control unit) in the front-rear direction and an incident range of θgu to θgd when the light forming the ghost image is incident on the light-transmitting image formation unit (and the light diffusion control unit) in the front-rear direction. Also for the aerial image forming device of Example 2, FIG. 6(b) illustrates as shaded areas an incident range of θar to θal when the light forming the aerial image is incident on the light-transmitting image formation unit (and the light diffusion control unit) in the right-left direction and an incident range of θgr to θgl when the light forming the ghost image is incident on the light-transmitting image formation unit (and the light diffusion control unit) in the right-left direction.

In the aerial image forming device according to Example 1, as illustrated in FIG. 6(a), it can be found that in the front-rear direction, the light diffusion control unit causes a sudden change in the haze value with the threshold being an incident angle of around −20°. It can also be found that the light diffusion control unit exhibits a low haze value (about 5%) in an incident range of eau to Oad related to the aerial image and exhibits a high haze value (about 80%) in an incident range of θgu to θgd related to the ghost image. That is, it has been found that the light diffusion control unit according to Example 1 can transmit light that forms an aerial image well in the front-rear direction and diffuse light that forms a ghost image.

In the aerial image forming device according to Example 2, as illustrated in FIG. 6(b), it can be found that in the right-left direction, the light diffusion control unit causes sudden changes in the haze value with the thresholds being incident angles of around −30° and 30°. It can also be found that the light diffusion control unit exhibits a low haze value (about 5%) in an incident range of far to θal related to the aerial image and exhibits a high haze value (about 80%) in an incident range of 0 gr to θgl related to the ghost image. That is, it has been found that the light diffusion control unit according to Example 2 can transmit light that forms an aerial image well in the right-left direction and diffuse light that forms a ghost image.

### <Testing Example 2> (Evaluation of Ghost Image Reduction and Brightness)

For the aerial image forming device prepared in each of Examples 1 and 3 and Comparative Examples 1 to 4, an image was displayed on the display unit to generate an aerial image, which was observed visually and captured as a still image. The observation conditions were as described in step (1) of Testing Example 1.

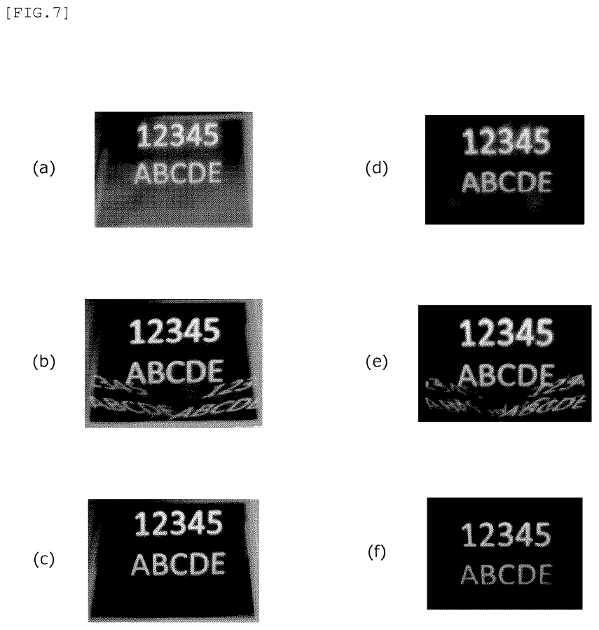

The captured images are shown in FIG. 7. FIG. 7(a) is an image according to Example 1, FIG. 7(b) is an image according to Comparative Example 1, FIG. 7(c) is an image according to Comparative Example 2, FIG. 7(d) is an image according to Example 3, FIG. 7(e) is an image according to Comparative Example 3, and FIG. 7(f) is an image according to Comparative Example 4. As apparent from these images, in the aerial image forming devices according to Comparative Example 1 and Comparative Example 3, ghost images occurred clearly on the right and left sides of the aerial images, whereas in the aerial image forming devices according to Examples 1 and 3 and Comparative Examples 2 and 4, the occurrence of ghost images was reduced to an extent that they were almost unnoticeable. When the aerial image forming device prepared in Example 2 was visually observed under the same conditions, it was confirmed that the occurrence of ghost images was reduced to an extent that they were almost unnoticeable.

Furthermore, for the purpose of confirming the brightness of the aerial image, the luminance (cd/m²) was measured when the entire surface of the display unit was displayed in white and when the entire surface was displayed in black, and the contrast ratio was calculated from these values. The luminance was measured using a KONICA MINOLTA Luminance Meter LS-110. For Examples 1 and 2 and Comparative Examples 1 and 2, the ambient illuminance was set to about 100 lx. On the other hand, for Example 3 and Comparative Examples 3 and 4, the ambient illuminance was set to about 20 lx because setting the ambient illuminance to about 100 lx would tend to cause periodic light and dark due to surface reflection, making accurate measurements impossible (these ambient illuminances were measured using a HIOKI LUX HiTESTER 3423). The measurement results are listed in Table 2.

TABLE 2

| | | Exam- | Comparative | Comparative | Exam- | Comparative | Comparative |
|---|---|---|---|---|---|---|---|
| | | ple 1 | Example 1 | Example 2 | ple 3 | Example 4 | Example [symbol] |
| Ambient | Luminance of white | 12.44 | 19.02 | [symbol] | Periodic light and dark due to | | |
| illuminance | display (cd/m²) | | | | surface reflection tended to occur, | | |
| 100 [symbol] | Luminance of black | [symbol] | 0.33 | 0.17 | and measurement was difficult | | |
| | display ( [symbol] /m²) | | | | | | |
| | Contrast ratio | [symbol] | [symbol] | [symbol] | | | |
| Ambient | Luminance of white | Not measured | | | [symbol] | 18.81 | [symbol] |
| illuminance | display ( [symbol] /m²) | | | | | | |
| 20 [symbol] | Luminance of black | | | | 0.23 | 0.31 | [symbol] |
| | display (cd/m²) | | | | | | |
| | Contrast ratio | | | | [symbol] | [symbol] | [symbol] |

[symbol]

indicates data missing or illegible when filed

According to Table 2, the aerial image forming device of Comparative Example 1 had the highest luminance in both the white display and the black display and the highest contrast ratio. This appears to be because the aerial image forming device does not include a light diffusion control unit or a privacy film. As described above, the aerial image forming device according to Comparative Example 1 clearly generates ghost images.

On the other hand, when comparing the aerial image forming device according to Example 1 including the light diffusion control unit with the aerial image forming device according to Comparative Example 2 including the privacy film, it can be found that the aerial image forming device according to Example 1 has higher brightness in both the white display and the black display and a higher contrast ratio. The same can be found when comparing the aerial image forming device according to Example 3 including the light diffusion control unit with the aerial image forming device according to Comparative Example 4 including the privacy film.

From the above, it can be found that the aerial image forming device according to Example 1 can satisfactorily reduce the occurrence of a ghost image while maintaining sufficient display brightness.

### INDUSTRIAL APPLICABILITY

The aerial image forming device of the present invention can be suitably used as a display that displays an aerial image, etc.

### DESCRIPTION OF REFERENCE NUMERALS

10 . . . . Aerial image forming device
   1 . . . Display unit
   2 . . . Light diffusion control unit
      201 . . . Plate-shaped region.
      202 . . . Region having relatively low refractive index
   3 . . . Light-transmitting image formation unit
4 . . . Aerial image observation surface
5 . . . Observation point
6 . . . Privacy film

1. An aerial image forming device comprising:
a display unit that has a display surface and emits light from the display surface;
a light diffusion control unit that is disposed on the display surface side of the display unit and diffuses or transmits the light depending on its incident angle; and
a light-transmitting image formation unit that is laminated on a surface side of the light diffusion control unit opposite to the display unit, transmits the light transmitted through the light diffusion control unit, and forms an image in a position on a surface side opposite to the light diffusion control unit,
the light diffusion control unit having a louver-shaped regular internal structure that includes a plurality of plate-shaped regions having a relatively high refractive index in a region having a relatively low refractive index.

2. The aerial image forming device according to claim 1, wherein the display unit is disposed with respect to the light diffusion control unit and the light-transmitting image formation unit such that the display surface and a surface of the light diffusion control unit opposite to the light-transmitting image formation unit are non-parallel.

3. The aerial image forming device according to claim 2, wherein,
when a direction perpendicular to a longitudinal direction of the plate-shaped regions and existing in the surface of the light diffusion control unit opposite to the light-transmitting image formation unit is defined as a first direction, and
a direction parallel to a plane perpendicular to both the display surface and one surface of the light diffusion control unit and existing in the surface of the light diffusion control unit opposite to the light-transmitting image formation unit is defined as a second direction,
an acute angle formed between the first direction and the second direction is 0° or more and 90° or less.

4. The aerial image forming device according to claim 1, wherein,
when a direction perpendicular to a longitudinal direction of the plate-shaped regions and existing in a surface of the light diffusion control unit opposite to the light-transmitting image formation unit is defined as a first direction,
each of the plate-shaped regions is tilted toward the first direction within the light diffusion control unit.

5. The aerial image forming device according to claim 4, wherein an angle of tilt of the plate-shaped regions is 0° or more and 30° or less with respect to a thickness direction of the light diffusion control unit.

6. The aerial image forming device according to claim 1, wherein the light-transmitting image formation unit includes a retro-transmitting optical element that retro-transmits incident light.

7. The aerial image forming device according to claim 6, wherein
the retro-transmitting optical element is configured such that two layers each including a plurality of reflective surfaces are laminated,
in each of the two layers, the plurality of reflective surfaces are arranged perpendicular to one surface of the retro-transmitting optical element and at a predetermined distance from each other, and
the two layers are laminated so that the reflective surfaces in one layer of the two layers are perpendicular to the reflective surfaces in the other layer of the two layers.

8. The aerial image forming device according to claim 7, wherein,
provided that a plane F that is perpendicular to both a surface of the light-transmitting image formation unit opposite to the light diffusion control unit and the display surface and that passes through a center point of the light-transmitting image formation unit is assumed and a width of the light-transmitting image formation unit in a cross section obtained by cutting the light-transmitting image formation unit at the plane F is width W,
upon observation of the aerial image forming device from an observation point that exists within the plane F and satisfies both of Condition A and Condition B below:
(Condition A)
when an angle between a line segment connecting the observation point and the center point and the surface of the light-transmitting image formation unit opposite to the light diffusion control unit is angle α, and an angle between a plane including the display surface of the display unit and a plane including the surface of the light-transmitting image formation unit opposite to the light diffusion control unit is angle β, a total of the angles α and β is 90°; and
(Condition B)
a distance between the observation point and the center point is 3.5 times the width W,
the light diffusion control unit is configured such that:
in the light that is emitted from any one point on the display unit and reaches the observation point, light that is reflected by both of the two layers constituting the retro-transmitting optical element gives a haze value of 60% or less; and
in the light that is emitted from any one point on the display unit and reaches the observation point, light that is reflected by only one of the two layers constituting the retro-transmitting optical element gives a haze value of 60% or more.
